(19) United States
(12) Patent Application Publication
(10) Pub. No.: US 2025/0209867 A1
(43) Pub. Date: Jun. 26, 2025

(54) MANAGEMENT DEVICE

(71) Applicant: TOYOTA JIDOSHA KABUSHIKI KAISHA, Toyota-shi (JP)

(72) Inventors: Yuki SUEHIRO, Susono-shi (JP); Shuichi Tamagawa, Kitanagoya-shi (JP)

(73) Assignee: TOYOTA JIDOSHA KABUSHIKI KAISHA, Toyota-shi (JP)

(21) Appl. No.: 18/794,237

(22) Filed: Aug. 5, 2024

(30) Foreign Application Priority Data
Dec. 22, 2023 (JP) 2023-216856

(51) Int. Cl. G07C 5/02

(52) U.S. Cl. CPC G07C 5/02

(57) ABSTRACT

The management device includes one or more processors and one or more storage devices that store mobility management information that manages a mobility state indicating a state of mobility. The one or more processors, based on the mobility management information, determine whether the mobility state is an abnormal state. In addition, the one or more processors determine that mobility assistance is necessary when the mobility state is determined to be an abnormal state and the standby time elapses after the mobility state is determined to be an abnormal state.

### CROSS-REFERENCE TO RELATED APPLICATION

This application claims priority to Japanese Patent Application No. 2023-216856 filed on Dec. 22, 2023, incorporated herein by reference in its entirety.

### BACKGROUND

### 1. Technical Field

The present disclosure relates to technology for managing a mobility.

### 2. Description of Related Art

Japanese Unexamined Patent Application Publication No. 2019-185279 (JP 2019-185279 A) discloses a management device for remotely controlling an autonomous vehicle. The management device decides a processing order based on a work time required for remote control, and a degree of priority, and assigns work for remote control to an operator in accordance with the processing order.

### SUMMARY

According to JP 2019-185279 A described above, when an abnormality occurs in the autonomous vehicle, there is no framework to determine whether the abnormality that is occurring is a temporary occurrence. As a result, there is concern that assistance requests that are actually unnecessary will be made prematurely. Accordingly, technology capable of appropriately determining whether assistance for an autonomous vehicle is necessary is desired.

One aspect of the present disclosure relates to a management device that manages mobility.

The management device includes

one or more processors, and
one or more storage devices that store mobility management information that manages a mobility state indicating a state of the mobility.

The one or more processors, based on the mobility management information, determine whether the mobility state is an abnormal state.

When the mobility state is determined to be an abnormal state, and also a standby time elapses after the mobility state transitions to the abnormal state, the one or more processors determine that the mobility needs assistance.

According to the present disclosure, when the mobility state is determined to be an abnormal state and also the standby time elapses after the mobility state transitions to an abnormal state, determination is made that the mobility needs assistance. As a result, assistance requests that are actually unnecessary can be suppressed from being made prematurely.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for explaining an outline of a mobility management system;

FIG. 2A is a diagram illustrating an example of an abnormal state of a mobility state;

FIG. 2B illustrates another example of an abnormal condition of a mobility condition;

FIG. 3A is a diagram illustrating a first example of a processing sequence of assistance determination;

FIG. 3B is a diagram illustrating another example of the first example of the process sequence of assistance determination;

FIG. 4A is a diagram illustrating a second example of a process sequence of assistance determination;

FIG. 4B is a diagram illustrating another example of the second example of the process sequence of assistance determination;

FIG. 5 is a flow chart illustrating an exemplary assistance determination process;

FIG. 6A is a diagram illustrating an example of a process sequence of assistance determination according to another embodiment; and

FIG. 6B is a diagram illustrating an example of a process sequence of assistance determination according to another embodiment.

### DETAILED DESCRIPTION OF EMBODIMENTS

Embodiments of the present disclosure will be described with reference to the accompanying drawings.

### 1. Mobility Management System Overview

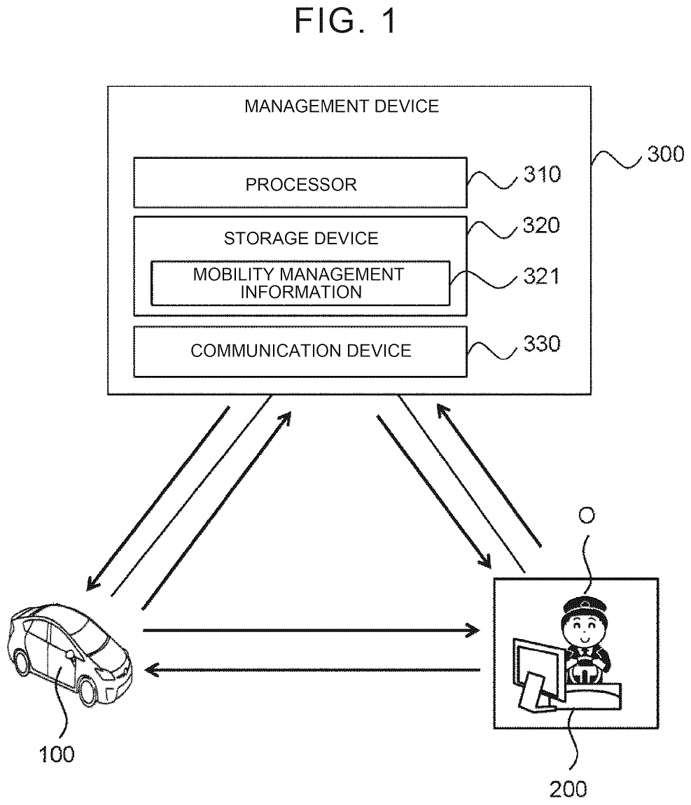

FIG. 1 is a conceptual diagram for explaining an outline of a mobility management system 1 according to the present embodiment. The mobility management system 1 is a system for managing mobility 100. The mobility management system 1 manages the state of the mobility 100. Furthermore, the mobility management system 1 may perform remote support of the mobility 100 when a request for remote support is received from the mobility 100. Remote supports are concepts that include, for example, remote monitoring, remote assistance, and remote driving.

The mobility management system 1 includes, for example, a mobility 100, a remote operator terminal 200, and a management device 300. The mobility 100, the remote operator terminal 200, and the management device 300 can communicate with each other via a communication network. For example, the mobility 100 can wirelessly communicate with the remote operator terminal 200 and the management device 300 via a wireless communication network. The remote operator terminal 200 and the management device 300 can communicate with each other via a wired/wireless communication network.

Mobility 100 is a mobile object that can be moved. The mobility 100 has an autonomous mobility function. The mobility 100 may include a self-diagnosis function for determining whether or not an abnormality has occurred. The type of mobility 100 to be managed is not limited to one, and may be a plurality. For example, the mobility 100 is a vehicle that travels on a public road. As another example, mobility 100 may be a vehicle used in a factory. As yet another example, mobility 100 may be a special compact vehicle. As yet another example, mobility 100 may be a construction machine. As yet another example, the mobility 100 may be a robot. As yet another example, mobility 100 may be a flying object. As yet another example, mobility 100 may be a ship. As yet another example, mobility 100 may be a vehicle in an amusement park.

The remote operator terminal 200 is a terminal device used when the remote operator O remotely supports the mobility 100. That is, remote operator terminal 200 is configured to be used by remote operator O for remote support of mobility 100. Examples of the remote operator terminal 200 include a cockpit-type terminal, a PC, tablets, and a smart phone.

The management device 300 is a computer that manages the mobility management system 1. The management device 300 manages mobility 100. The management device 300 may include a plurality of servers that perform distributed processing. For example, the management device 300 may manage a plurality of remote operators O and a plurality of remote operator terminals 200. The management device 300 may also assign the remote operator O and the remote operator terminal 200 to remote support of the mobility 100 in response to the remote support request.

The management device 300 includes one or more processors 310 (hereinafter, simply referred to as processors 310), one or more storage devices 320 (hereinafter, simply referred to as storage devices 320), and a communication device 330. The communication device 330 communicates with the mobility 100 and the remote operator terminal 200.

The processor 310 executes various processes. Exemplary processors 310 include general purpose processors, special purpose processors, CPU, GPU, ASIC, FPGA, integrated circuits, conventional circuits, and/or combinations thereof. The processor 310 may also be referred to as a circuitry or a processing circuitry. Circuitry is hardware programmed to implement the described functions, or hardware that performs the functions. The storage device 320 stores various types of information. Examples of the storage device 320 include a volatile memory, a nonvolatile memory, and a HDD, SSD. The functions of the management device 300 may be realized by cooperation of the processor 310 executing the management program and the storage device 320. The management program is stored in the storage device 320. Alternatively, the management program may be recorded in a computer-readable recording medium. The management program may be provided via a network.

The various types of information stored in the storage device 320 include mobility management information 321. The mobility management information 321 is information for managing a mobility state indicating a state of the mobility 100. The mobility state includes, for example, a self-diagnosis result (also referred to as a self-state) of the mobility 100 itself and a communication state with the mobility 100. That is, the mobility management information 321 includes information acquired from the mobility 100 and information recorded by monitoring of the management device 300. Details of the mobility state will be described later.

The processor 310 (management device 300) according to the present embodiment executes assistance determination processing. The assistance determination processing by the processor 310 is executed, for example, while the mobility 100 is traveling. An outline of the assistance determination processing is as follows. The processor 310 determines whether or not the mobility state is an abnormal state based on the mobility management information 321. Then, the processor 310 determines that assistance of the mobility 100 is necessary when the mobility state is determined to be an abnormal state and the standby time elapses after the mobility state is determined to be an abnormal state. As a result, assistance requests that are actually unnecessary can be suppressed from being made prematurely.

### 2. Mobility State Examples

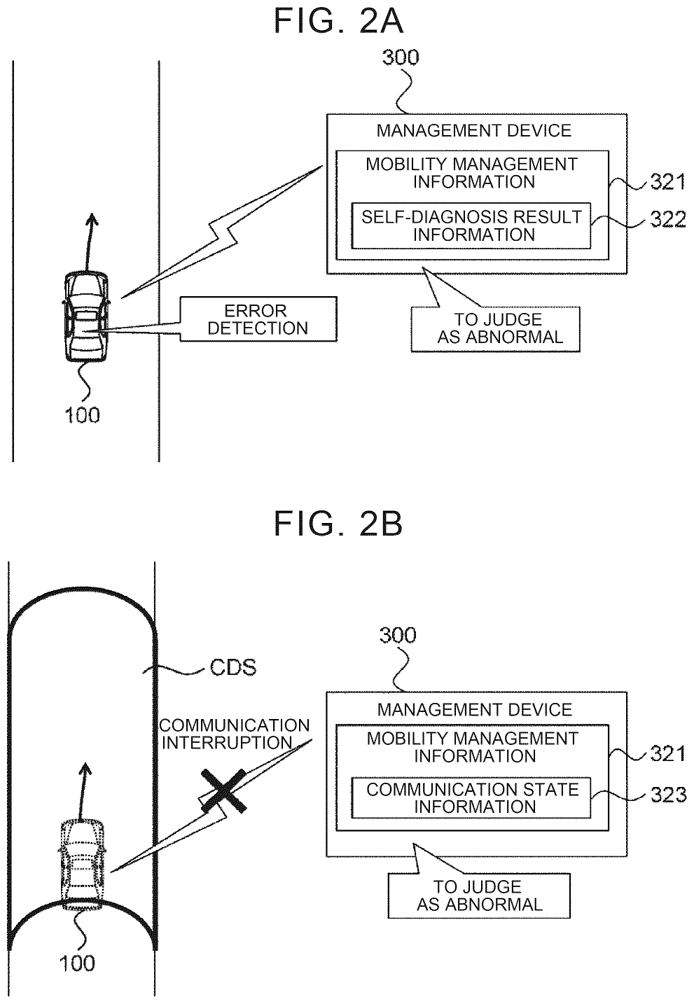

FIGS. 2A and 2B are diagrams illustrating exemplary abnormal states in a mobility state. As described above, the mobility state includes a self-diagnosis result of the mobility 100 and a communication state with the mobility 100. The management device 300 determines whether or not the mobility state is an abnormal state. Details of the abnormal state determination example will be described below.

### 2-1. First Example

FIG. 2A shows an exemplary determination of an abnormal condition based on the self-diagnosis of the mobility 100. The mobility management information 321 includes self-diagnosis result information 322. The self-diagnosis result information 322 is information indicating a self-diagnosis result of determining whether the mobility 100 itself is normal or abnormal. The self-diagnosis result information 322 is acquired from the mobility 100 via communication. The management device 300 determines whether or not the mobility 100 has detected an abnormality based on the self-diagnosis result information 322. When it is determined that the mobility 100 has detected an abnormality, the management device 300 determines that the mobility state is an abnormal state.

### 2-2. Second Example

FIG. 2B illustrates an exemplary determination of a mobility state based on a communication state of mobility 100. The mobility management information 321 includes communication state information 323. The communication state information 323 indicates a communication state with the mobility 100. Examples of the communication state include presence/absence of communication, communication speed, communication quality, and communication delay. The management device 300 may acquire (detect, estimate) a communication state based on data received from the mobility 100. For example, when the mobility 100 travels in a predetermined section CDS (e.g., a tunnel) where communication interruption occurs, communication between the mobility 100 and the management device 300 is interrupted. In this case, the communication state information 323 indicates that a communication interruption has occurred. When communication with the mobility 100 is interrupted, the management device 300 determines that the mobility state is an abnormal state.

### 3. Outline of Assistance Decisions

Consider assistance decisions when the mobility status becomes abnormal. For example, in the first embodiment described above, as shown in FIG. 2A, when the mobility 100 detects an abnormality, that is, when the self-diagnosis result information 322 acquired from the mobility 100 includes an abnormality, the mobility 100 performs its own recovery process. In this case, although there is a possibility that the mobility state returns normally after completion of the recovery process by the mobility 100, the management device 300 may determine that assistance of the mobility 100 is necessary during execution of the recovery process. In the first example, it is preferable to determine whether or not mobility 100 assistance is necessary, considering that the recovery process may succeed if waited to some extent. Note that the return process includes, for example, a process of restarting a device that is estimated to have an abnormality.

As another example, in the second example described above, the mobility 100 travels in a predetermined section CDS in which communication interruption occurs. In this situation, the management device 300 may determine that the mobility 100 needs assistance even though the communication may be recovered if the mobility 100 passes through the predetermined section CDS. In the second example, it is preferable to determine whether mobility 100 assistance is necessary, considering that communication may recover if waited to some extent.

Therefore, the management device 300 according to the present embodiment determines that the mobility 100 needs assistance when the mobility state is determined to be an abnormal state and the standby time elapses after the mobility state is determined to be an abnormal state. The waiting time may be a fixed value (default value) or may be variably set according to the situation. Details of an example of assistance determination will be described below.

### 4. Examples of Assistance Decisions

### 4-1. First Example

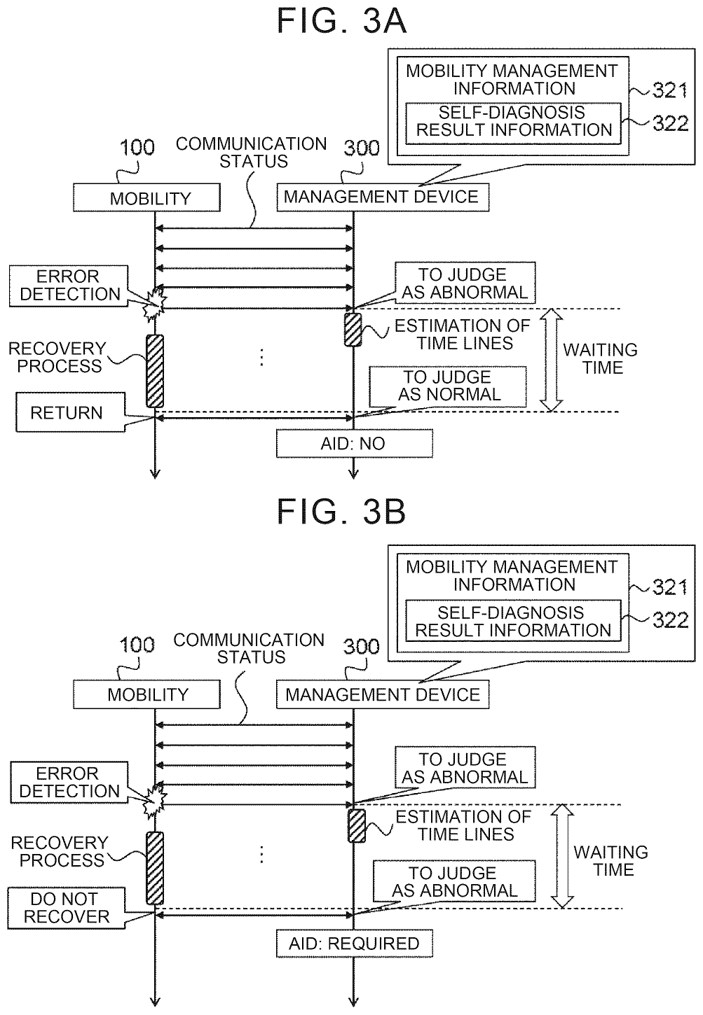

FIG. 3A is a diagram illustrating a first example of a processing sequence of assistance determination; According to the first example of the assistance determination, when the mobility 100 detects an abnormality, that is, when the self-diagnosis result information 322 includes an abnormality, the management device 300 does not determine that the assistance of the mobility is necessary until the waiting time elapses.

The management device 300 may estimate a time (also referred to as a required time) required for the mobility 100 to complete the recovery process after detecting the abnormality. When the self-diagnosis result information 322 includes information on an abnormality detection portion indicating a portion where the mobility 100 detects an abnormality, the management device 300 may estimate the required time based on the list information including the required time associated with the abnormality detection portion. For example, the list information includes information indicating that the required time in the case where the abnormality detection location is a communication device mounted in the mobility 100 is 60 seconds. After estimating the required time, the management device 300 may set the waiting time to be longer than the estimated required time. In the case where the required time is estimated, a time longer than the time until the estimation of the required time is completed may be set as the initial value of the waiting time. As another example, the management device 300 may disable the processing related to the assistance determination so that the assistance determination is not performed until the estimation of the required time is completed.

After setting the waiting time, the management device 300 determines whether or not assistance of the mobility 100 is necessary after the waiting time elapses. For example, as shown in FIG. 3A, when the mobility state (self-state) has returned from the abnormal state to the normal state after the waiting time has elapsed, the management device 300 determines that assistance of the mobility 100 is not necessary. That is, when the self-diagnosis result information 322 is normally switched from abnormal, the management device 300 determines that assistance of the mobility 100 is unnecessary.

As another example, as shown in FIG. 3B, when the mobility state (self-state) remains in the abnormal state after the waiting time elapses, the management device 300 determines that assistance of the mobility 100 is required. That is, when the self-diagnosis result information 322 maintains the abnormality, the management device 300 determines that assistance of the mobility 100 is necessary.

### 4-2. Second Example

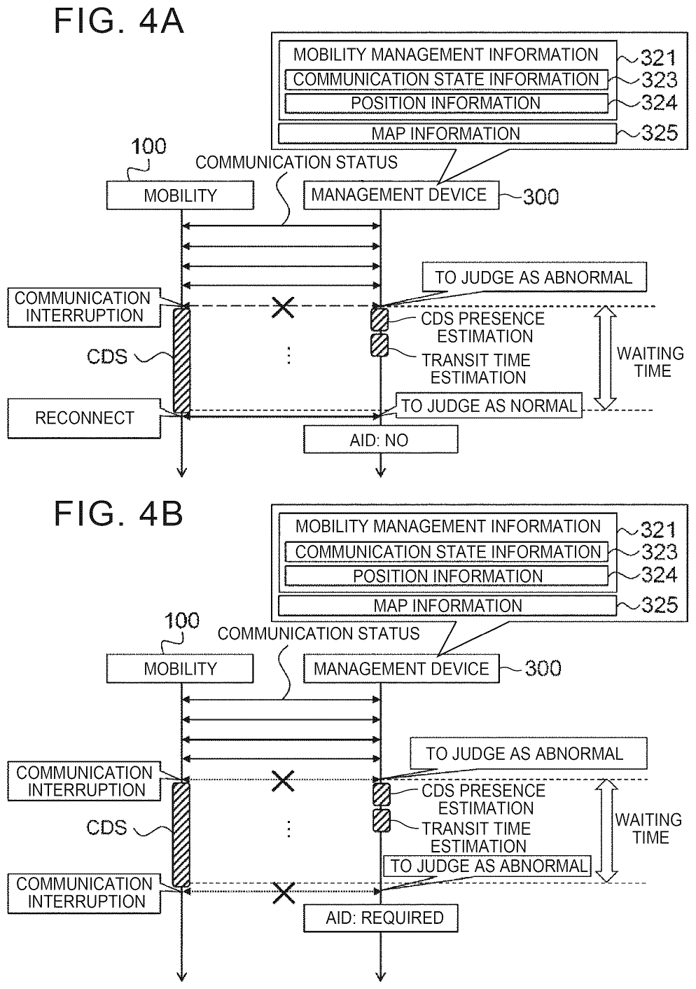

FIG. 4A is a diagram illustrating a second example of a process sequence of assistance determination; According to the second example of the assistance determination, when the communication with the mobility 100 is interrupted, the management device 300 does not determine that the assistance of the mobility is necessary until the waiting time elapses.

The management device 300 may estimate whether the mobility 100 exists in a predetermined section CDS (e.g., tunneling) in which communication interruption occurs. For example, the mobility management information 321 further includes position information 324 (hereinafter simply referred to as position information 324) of the mobility 100, and the storage device 320 further stores the map information 325. The position information 324 includes current position information indicating the current position of the mobility 100 and a history (also referred to as historical position information) of the position information of the mobility 100. position information 324 is obtained from mobility 100. The position information 324 acquired by the mobility 100 is acquired by, for example, a sensor such as a GPS installed in the mobility 100. The map information 325 includes information on a predetermined section CDS (e.g., tunneling) in which communication interruption occurs.

It is assumed that the mobility 100 is present in the predetermined section CDS. In this case, a sensor such as a GPS mounted in the mobility 100 cannot acquire the present position information. Therefore, by using the history position information in the position information 324, it is possible to estimate whether or not the mobility 100 is entering the predetermined section CDS, that is, whether or not the mobility 100 exists in the predetermined section CDS. Therefore, when communication with the mobility 100 is interrupted, the management device 300 estimates whether or not the mobility 100 exists in the predetermined section CDS based on the map information 325 and the history position information. That is, when the communication state information 323 includes information related to communication interruption, the management device 300 estimates whether or not the mobility 100 exists in the predetermined section CDS based on the map information 325 and the history position information. For example, when the position of the mobility 100 estimated by the history position information is included in the predetermined section CDS, the management device 300 estimates that the mobility 100 exists in the predetermined section CDS.

When it is estimated that the mobility 100 exists in the predetermined section CDS, the management device 300 may estimate a time (also referred to as a transit time) required for the mobility 100 to pass through the predetermined section CDS. The transit time is estimated based on, for example, distance information of a predetermined section CDS acquired by the map information 325 and vehicle speed information of the mobility 100. As the vehicle speed information, for example, one obtained last from the mobility 100 is used. Alternatively, the vehicle speed of the mobility 100 may be estimated based on the historical position information. After estimating the passing time, the management device 300 may set the waiting time to be longer than the estimated passing time. In the case where the estimation of the passing time is performed, a time longer than the time until the completion of the estimation of the passing time may be set as the initial value of the waiting time. As another example, the management device 300 may disable the processing related to the assistance determination so that the assistance determination is not performed until the estimation of the transit time is completed.

After setting the waiting time, the management device 300 determines whether or not assistance of the mobility 100 is necessary after the waiting time elapses. For example, as shown in FIG. 4A, when the mobility state (communication state) has returned from the abnormal state to the normal state after the waiting time has elapsed, the management device 300 determines that assistance of the mobility 100 is not necessary. That is, when the communication state information 323 is switched from the communication interruption to the information related to the reconnection, the management device 300 determines that assistance of the mobility 100 is unnecessary.

As another example, as shown in FIG. 4B, when the mobility state (communication state) remains in the abnormal state after the waiting time elapses, the management device 300 determines that assistance of the mobility 100 is required. That is, when the communication state information 323 maintains the information on the communication interruption, the management device 300 determines that assistance of the mobility 100 is necessary.

### 5. Example of Processing

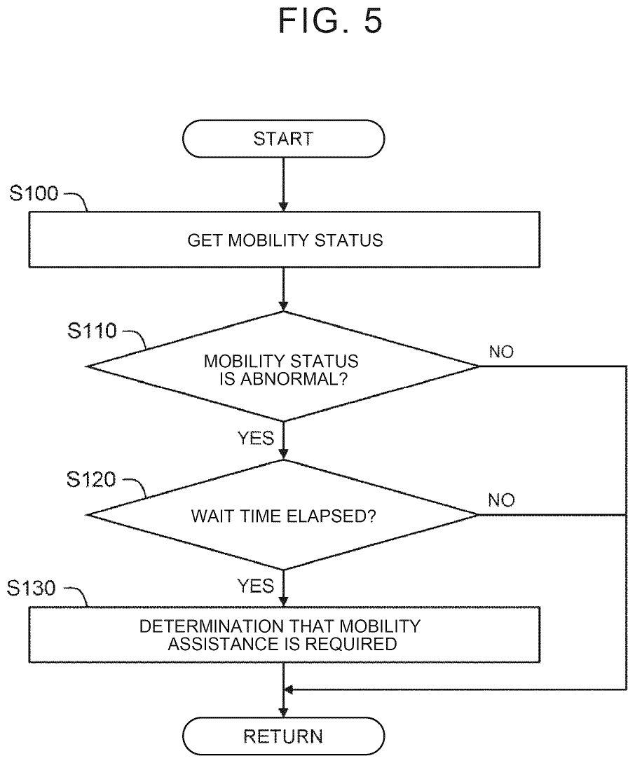

FIG. 5 is a flowchart illustrating an example of assistance determination processing performed by the management device 300 according to the present embodiment.

In step 100, the management device 300 acquires the mobility state. Thereafter, the process proceeds to S110. The mobility state is managed by the mobility management information 321.

In S110, the management device 300 determines whether or not the mobility state is an abnormal state. If the mobility state is determined to be an abnormal state (S110; Yes), the process proceeds to S120. Otherwise (S110; No), the process ends.

In S120, the management device 300 determines whether or not the standby period has elapsed since the mobility state became an abnormal state. If it is determined that the waiting period has elapsed (S120; Yes), the process proceeds to S130. Otherwise (S120; No), the process ends.

In S130, the management device 300 determines that mobility 100 needs assistance.

### 6. Effect

According to the present embodiment, when the mobility state is determined to be an abnormal state and the standby time elapses after the mobility state becomes an abnormal state, it is determined that mobility assistance is necessary. For example, when the mobility 100 detects an abnormality and then performs a recovery process, or when the mobility 100 exists in a predetermined section CDS (e.g., tunnels) in which a communication interruption occurs temporarily, there is a possibility that the mobility may recover from an abnormal condition after a short wait. In such a case, it is possible to suppress an assistance request that was originally unnecessary from being sent ahead.

### 7. Other Embodiments

Other embodiments propose a response if mobility 100 assistance is determined to be required.

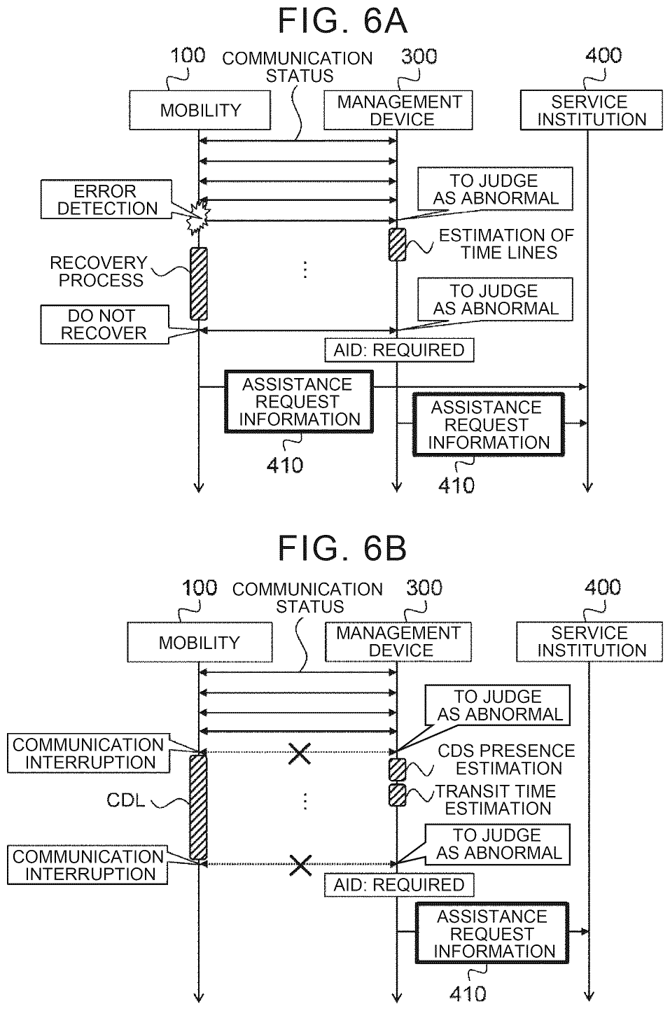

FIGS. 6A and 6B are diagrams illustrating an example of a processing sequence of assistance determination according to another embodiment. When it is determined that assistance of the mobility 100 is necessary, the management device 300 transmits the assistance request information 410 to the service institution 400 via the communication device 330. The service institution 400 is an institution that performs a load service. Examples of the service institution 400 include JAF, police, and the like. The assistance request information 410 includes the location of the mobility 100 when the mobility state becomes abnormal or when it is determined that assistance of the mobility 100 is necessary. That is, the storage device 320 according to another embodiment includes at least the position information 324. The communication device 330 is configured to be able to communicate with the service institution 400.

According to another embodiment, assistance request information 410 including a location of mobility 100 when a mobility state becomes an abnormal state or when mobility assistance is determined to be necessary is transmitted to service institution 400. Accordingly, assistance to the mobility 100 can be smoothly performed.

The transmission of the assistance request information 410 to the service institution 400 is not limited to the management device 300. For example, as illustrated in FIG. 6A, in a case where the mobility 100 does not return even if the return process is performed, the mobility 100 may transmit the assistance request information 410 to the service institution 400.

What is claimed is:

1. A management device for managing a mobility, the management device comprising:
one or more processors; and
one or more storage devices that store mobility management information that manages a mobility state indicating a state of the mobility, wherein the one or more processors are configured to,
based on the mobility management information, determine whether the mobility state is an abnormal state, and
when the mobility state is determined to be an abnormal state, and also a standby time elapses after the mobility state transitions to the abnormal state, determine that the mobility needs assistance.

2. The management device according to claim 1, wherein:
the mobility state includes a communication state of the mobility; and
the one or more processors are configured to determine that the mobility state is the abnormal state when communication with the mobility is lost.

3. The management device according to claim 2, wherein:
the one or more storage devices further store map information including a predetermined section in which lost communication occurs;
the mobility management information includes position information of the mobility; and
the one or more processors are configured to further
estimate whether the mobility is present in the predetermined section, based on the map information and history of the position information,
estimate time required for the mobility to pass through the predetermined section, when it is estimated that the mobility is present in the predetermined section, and
set the standby time to be longer than the estimated time.

4. The management device according to claim 1, wherein:
the mobility management information includes self-diagnosis result information indicating a result of determining whether the mobility itself is normal or abnormal; and
the one or more processors are configured to further
determine whether the mobility has detected an abnormality, based on the self-diagnosis result information,
estimate time required for the mobility to complete recovery processing after detecting the abnormality, and
set the standby time so as to be longer than the estimated time.

5. The management device according to claim 1, further comprising a communication device that is communicable with a service entity that performs roadside service, wherein:
the mobility management information includes the position information of the mobility; and
the one or more processors are configured to, when the mobility state transitions to the abnormal state or when determination is made that the mobility needs assistance, an assistance request information including a position of the mobility is transmitted to the service entity via the communication device.
